(19) United States
(12) Patent Application Publication
(10) Pub. No.: US 2026/0055026 A1
(43) Pub. Date: Feb. 26, 2026

(54) CONCRETE RECYCLING SYSTEM AND METHOD OF USE

(71) Applicant: Phillip James Hickernell, Upland, CA (US)

(72) Inventor: Phillip James Hickernell, Upland, CA (US)

(21) Appl. No.: 18/811,132

(22) Filed: Aug. 21, 2024

(51) Int. Cl. C04B 18/167; B01D 21/26; B01D 33/03; B28C 5/08

(52) U.S. Cl. CPC C04B 18/167; B01D 21/267; B01D 33/0346; B28C 5/0831; B28C 5/0887

(57) ABSTRACT

A concrete recycling system and a method of use thereof is disclosed. The concrete recycling system may recycle aggregates and sand from fluid-concrete based on their grain size. Particularly, the concrete recycling system may have a slurry refiner that allows for the finer aggregates in the fluid-concrete to be recycled. The fluid-concrete may be diluted by water and fed to the slurry refiner via a fluid outlet having a turbulent discharge. The slurry refiner may allow the finer aggregates to settle to the bottom of said device for an auger system to uniformly mix the aggregates and transfer them along the length of the slurry refiner. The uniformly mixed slurry may then be pumped to a hydrocyclone to separate the finer aggregates from the cement and water in the slurry.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The various aspects and embodiments described herein relate to a concrete recycling system and a method of use thereof.

Concrete is used in many construction projects to build structures out of such material. To use concrete, however, such composition needs to be transferred to the construction site in fluid form. One or more mixer trucks may be used to dispatch fluid-concrete to the construction site. When the mixer trucks are finished providing fluid-concrete to the construction site, such vehicles may return to the concrete-making plant to discharge and recycle any unused fluid-concrete left in their reserves.

Accordingly, there is a need in the art for an improved device, system, and method for concrete recycling.

### BRIEF SUMMARY

The various embodiments and aspects disclosed herein address the needs discussed above, discussed below and those that are known in the art.

A concrete recycling system and a method of use thereof is disclosed. The concrete recycling system may recycle aggregates and sand from fluid-concrete based on their grain size. The fluid-concrete may be diluted by water and be fed through a filtering system to separate the larger aggregates first from the diluted concrete slurry. The diluted concrete slurry may then flow downstream to have the finer aggregates separated therefrom. Particularly, the concrete recycling system may have a slurry refiner that allows for the finer aggregates in the fluid concrete to be recycled. The filtered and diluted concrete slurry may be fed to the slurry refiner via a fluid outlet having a turbulent discharge. The turbulent discharge may agitate the finer aggregates in the diluted concrete slurry to allow such aggregates to separate from cement binders and ultra-fine aggregates. The slurry refiner may allow the finer aggregates to settle to the bottom of said device for an auger system to uniformly mix the aggregates and transfer them along the length of the slurry refiner. The uniformly mixed slurry may then be pumped to a separating device, such as a hydrocyclone, to separate the finer aggregates from the cement and water in the slurry.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a first view of a slurry refiner that may be used in a concrete reclaimer system;

FIG. 2 shows a concrete reclaimer system having the slurry refiner shown in FIG. 1;

FIG. 3A shows a close-up inside view of a portion of the mesh filtering system of FIG. 2;

FIG. 3B shows a top view of the slurry refiner of FIG. 2 in a deactivated mode;

FIG. 3C shows a top view of the slurry refiner of FIG. 2 in an activated mode;

FIG. 3D shows an inside cross-sectional view of the hydrocyclone in FIG. 2 in operation;

FIG. 3E shows a side view of the slurry refiner of FIG. 2; and

FIG. 3F shows a front view of the slurry refiner of FIG. 2.

### DETAILED DESCRIPTION

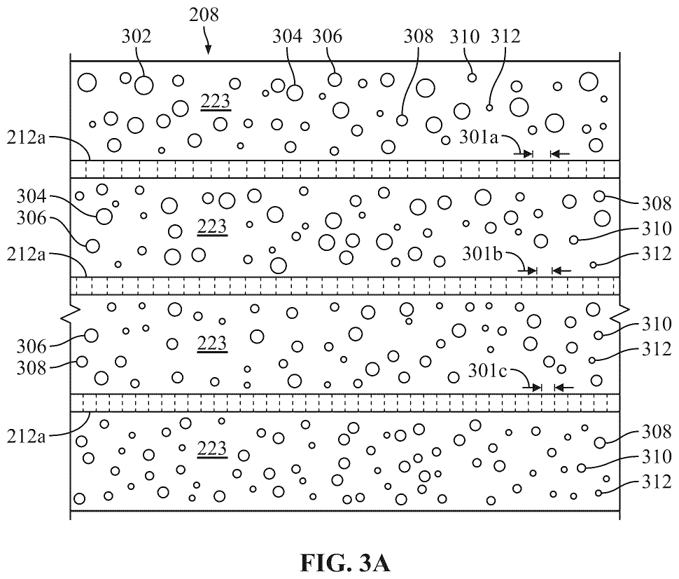

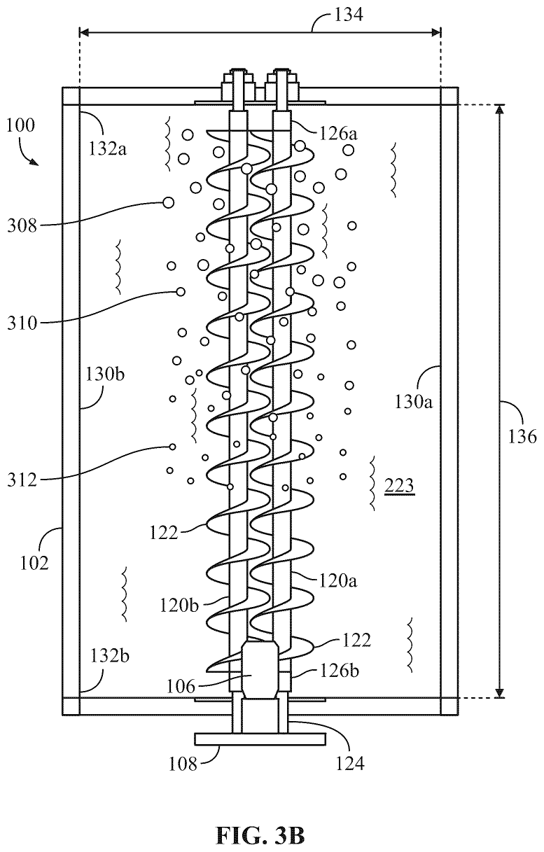

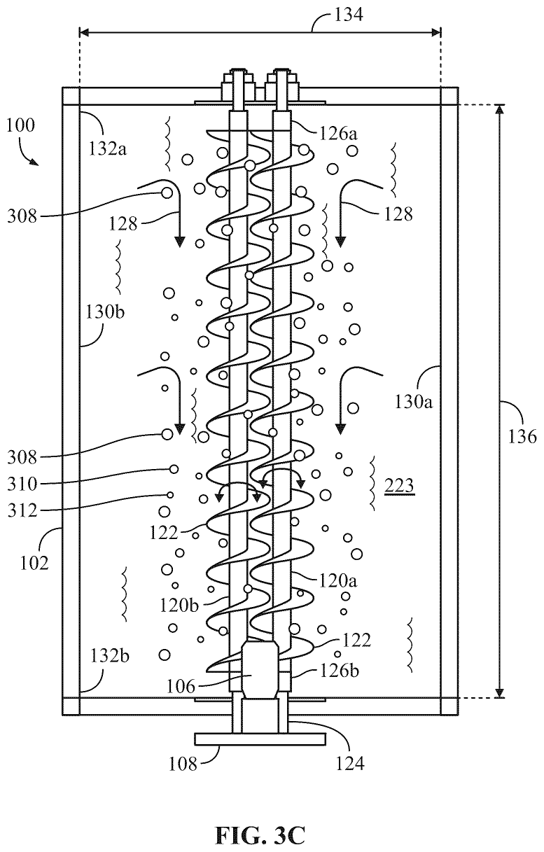

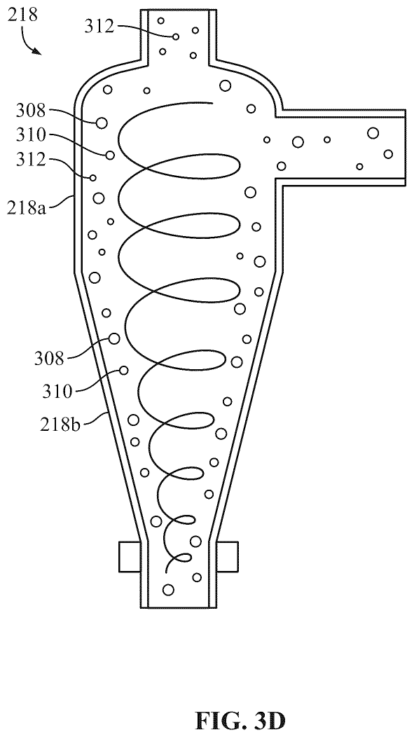

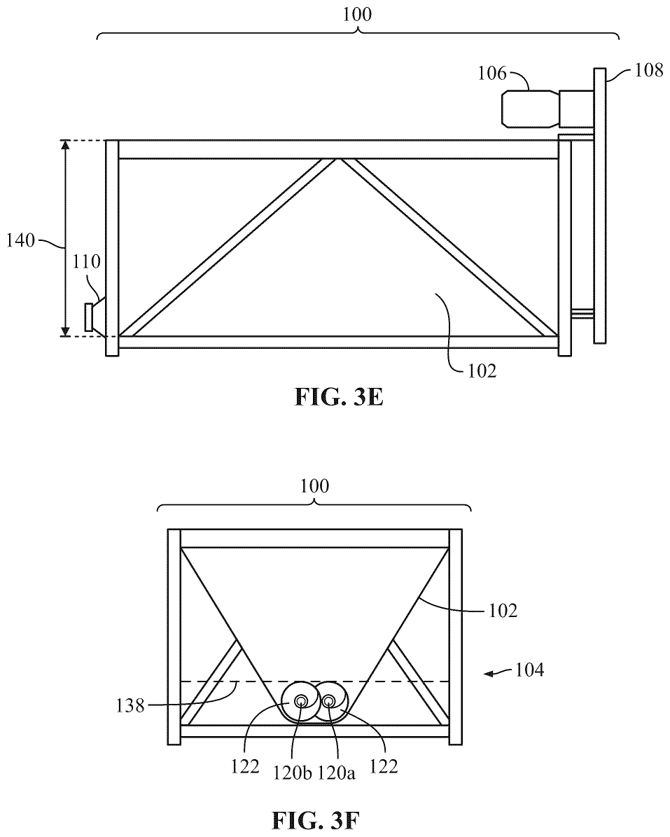

Throughout the description herein, the flow rate of water, fluid-concrete, and diluted concrete slurry may be described in terms of volumetric flow rate. However, the mass flow rate of such fluids is also contemplated herein and the descriptions regarding the volumetric flow rate, described elsewhere herein, may apply to the mass flow rate of the aforementioned fluids. The sizes of the aggregates of the concrete, specifically in the diluted concrete slurry 223 shown in the FIGS. 3A-D, may not be of scale and may be exaggerated to create visual clarity in the figures. Additionally, not all of the aggregate particles are shown, for example in FIGS. 3A-D, for sake of clarity in the drawings.

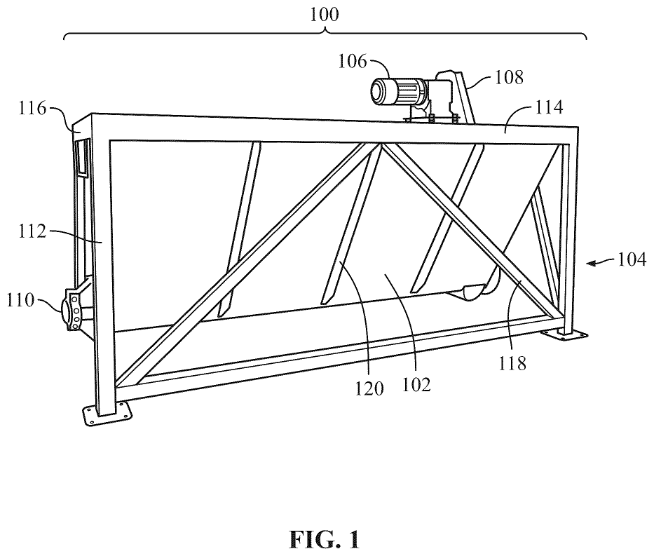

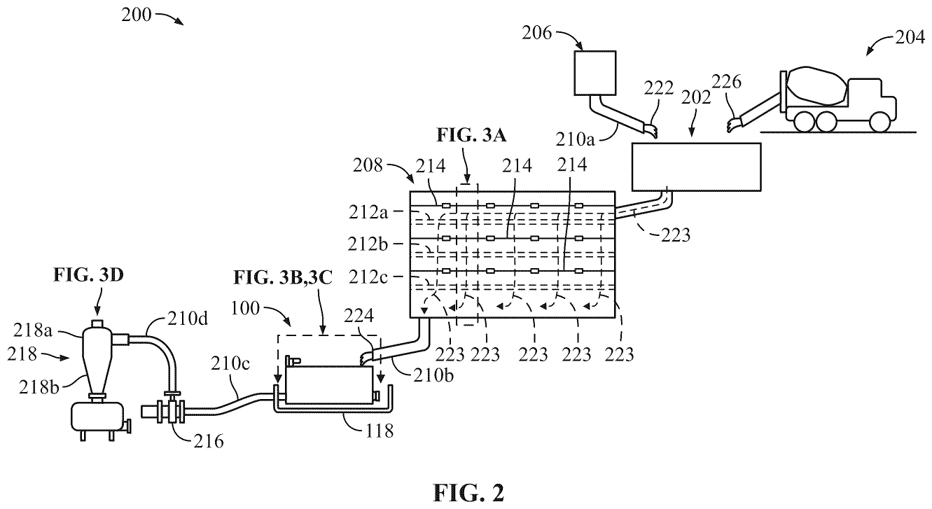

Referring now to FIG. 1, a first view of a slurry refiner 100 is shown. The slurry refiner 100 may be part of a concrete reclaimer system 200, as shown in FIG. 2, and help reclaim fine aggregates that do not get filtered and captured by the reclaiming structures (e.g., mesh filtering system 208) upstream from the slurry refiner 100 in the reclaimer system 200. As shown in FIG. 2, the concrete reclaimer system 200 may be in the form of a factory and have one or more building structures as part of the system. The slurry refiner 100 may recycle fine aggregates (e.g., sand) from the fluid concrete 226 fed into the system 200 with the usage of turbulent discharge 224 of a diluted concrete slurry 223 into the slurry refiner 100. The slurry refiner 100 may slow down the velocity of the turbulent discharge 224, uniformly mix the diluted concrete slurry 223 (see FIG. 3C), and convey such fluid to a hydcrocylone 218 for the separation of the fine aggregates.

As shown in FIG. 2, the slurry refiner 100 of FIG. 1 may be part of a broader concrete reclaimer system 200 having multiple structures to thoroughly recycle, separate, and reclaim the useful elements of the fluid-concrete 226 that is being fed into the reclaimer system 200. The concrete reclaiming process may begin with the fluid concrete 226 being discharged from a mixer truck 204 into a receiving hopper 202 and to be mixed with a large quantity of recycled water 222. The mixing of the fluid concrete 226 with the recycled water 222 is designed to create a diluted slurry 223 that helps other structures (e.g., slurry refiner 100) downstream of the receiving hopper 202 to function optimally. The diluted slurry 223 may move downstream from the receiving hopper 202 and on top of a mesh filtering system 208 having a plurality of vibratory mesh screens 212a-c. The mesh filtering system 208 may separate the larger sized aggregates from the diluted concrete slurry 223 using the vibratory screens 212a-c layers above each other and with water sprayed thereon by spray bars 214.

When the larger sized aggregates are removed from the diluted concrete slurry 223, the rest of the fluid having finer aggregates may flow downstream and enter the slurry refiner 100 via a turbulent discharge 224. The turbulent discharge 224 may help separate cement particles from the finer aggregates in the filtered diluted concrete slurry 223. The slurry refiner 100 may slow down the fluid velocity of the turbulent discharge 224 of the concrete slurry having the finer aggregates to allow the remaining aggregates to settle near the bottom 138 (see FIGS. 3B and 3F) of the slurry refiner 100. The slurry refiner 100 may uniformly mix the finer sized aggregates remaining in the diluted concrete slurry 223 near the bottom 138 of the device and convey the mixture along the length of the slurry refiner 100 (see FIG. 3C), where a slurry pump 216 (see FIG. 2) may feed such mixture to a hydrocyclone 218. The hydrocyclone 218 may then separate the finer aggregates in the mixture from other relatively smaller aggregates, cement particles, and water. The separated finer aggregates may be stored and transported for reuse, and the water used in the system and ejected from the hydrocyclone 218 may be recycled and reused in the system as the recycled water 222.

Referring specifically to the slurry refiner 100, the device may be a large open container designed for blending the agitated, quasi-filtered, and diluted slurry 223 flowing from the mesh filtering system 208 through the turbulent discharge 224 of the second piping 210b. The uniform mixture of the turbulent discharge 224 created by the slurry refiner 100 may allow the hydrocyclone 218 receiving such mixture to perform optimally when separating the fine aggregate from water, cement, and ultra-fine aggregate in the mixture. As shown in FIG. 3C, the uniform mixture may be created by one or more augers 120a-b extending along the inside length 136 of the container body 102 of the slurry refiner 100. The augers 120a-b may rotate their auger blades 122 to create a flow 128 that is inwards and forward inside the container body 102, as described elsewhere herein. The rotational motion of the augers 120a-b may also mix together the fine aggregates that were agitated at the turbulent discharge 224, the agitation separating such aggregates from the cement particles and ultra fine aggregates, such that the mixture is uniform and has fine aggregates at the desire size range. More details about the structures and functions of the slurry refiner 100 will be described elsewhere herein.

Referring back to FIG. 2, a detailed explanation of the concrete reclaimer system 200, the process of reclaiming unused fluid-concrete, and the utilization of the slurry refiner 100 will be explained herein. To initialize the process, mixer trucks 204 may dump their unused fluid-concrete 226 inside a receiving hopper 202 for reclaiming, recycling, and reusing the elements that make up the fluid-concrete 226 composition. A water source 210a may also add water 222 to the receiving hopper 202 to mix with and dilute the fluid-concrete 226 dumped by the mixer trucks 204 in the receiving hopper 202. The diluted concrete slurry 223 created in the receiving hopper 202 may then flow downstream towards a mesh filtering system 208.

When deployed to project sites, the mixer trucks 204 may carry more fluid-concrete 226 than required for construction to ensure there would be no shortage of fluid-concrete at the project site. When the mixer trucks 204 are done supplying fluid-concrete 226 at the project site, they may return to the concrete plant to discharge and empty the additional yardage of fluid-concrete remaining in their reserves. Each mixture truck 204 returning to the concrete plant may discharge fluid-concrete 226 at different flow rates inside the receiving hopper 202 (e.g., some mixer trucks 204 discharging fluid-concrete 226 in the receiving hopper 202 faster than other trucks). Such variation in the fluid-concrete 226 discharge rate inside the receiving hopper 202 may hinder the reclaiming process. Consequently, a relatively large amount of water 222 may be added to the receiving hopper 202 while fluid-concrete 226 is being discharged therein to create a diluted concrete slurry 223. The amount of water 222 added to the receiving hopper 202 may be so much that the fluid-concrete 226 is diluted substantially where the varying rate of concrete discharge rate by the mixer trucks 204 becomes negligible and does not offset the concrete reclaimer system 200.

The fluid-concrete 226 may be made of gravel, sand, crushed stone, cement binder, water, and other materials. The gravel and crushed stone may come in large (e.g., greater than or equal to 1 inch grain size), medium (e.g., less than 1 inch but greater than or equal ⅜ inch grain size), and small aggregates (e.g., less than ⅜ inch but greater than or equal ⅛ inch grain size). The sand may come in small, fine (e.g., less than or equal to ⅛ inch but greater than or equal to 1/32 inch grain size), extra fine aggregates (e.g., less than 1/32 inch but greater than or equal to 1/64 inch grain size), and ultra fine aggregate (e.g., less than 1/64 inch but greater than or equal to 1/128 inch grain size). The cement binder may have a grain size less than the ultra fine size described herein. The mesh filtering system 208 may separate the large, medium, and small aggregates for reuse, as shown in FIG. 3A and described elsewhere herein. The slurry refiner 100 along with the hydrocyclone 218 may separate the fine and extra fine, and even the ultra-fine aggregates for reuse, as shown in FIGS. 3B-D and described elsewhere herein. The sump 118 surrounding the slurry refiner 100 (see FIG. 2) and receiving spill-over water may transfer such water having ultra-fine aggregates and cement for press-fitting to separate such particles from water for recycling and reuse.

The water 222 used to dilute the fluid-concrete 226 may be recycled water from the concrete reclaimer system 200, for example coming from the outflow of the hydrocylcone 218 and the press-fitted water coming from the sump 118. The recycled water 222 may be stored in a storage tank 206 (e.g., water tower) and be fed to the receiving hopper 202 via a water source pipe 210a. The flow rate of the recycled water 222 into the receiving hopper 202 to dilute the fluid-concrete 226 and create the diluted concrete slurry 223 may be greater than or equal to 1,000 gallons of water per minute. The flow rate of the recycled water 222 into the receiving hopper 202 to dilute the fluid-concrete 226 and create the diluted concrete slurry 223 may be less than or equal to 3,000 gallons of water per minute. The flow rate of the recycled water 222 into the receiving hopper 202 to dilute the fluid-concrete 226 and create the diluted concrete slurry 223 may be greater than or equal to 1,000 gallons and less than or equal to 3,000 gallons of water per minute. The discharge flow rate of the fluid-concrete 226 in the receiving hopper 202 for dilution may be less than the flow rate of water 222, described elsewhere herein. The flow rate of water 222 may be between five times to 100 times the flow rate of the fluid-concrete 226 in the receiving hopper 202. The flow rate of water 222 may be greater than or equal to five times the flow rate of the fluid-concrete 226 in the receiving hopper 202. The flow rate of water 222 may be less than or equal to 100 times the flow rate of the fluid-concrete 226 in the receiving hopper 202. The discharge flow rate of the fluid-concrete 226 may vary since different drivers of different mixer trucks 204 may dump the excess fluid concrete at different flow rates.

When the fluid-concrete 226 is mixed and diluted by the recycled water 222 in the receiving hopper 202 to create the diluted concrete slurry 223, such slurry may then move downstream to the mesh filtering system 208 to reclaim and recycle the larger aggregates first from the slurry. As shown in FIG. 3A, the mesh filtering system 208 may have a plurality of filtering screens 212a-c stacked above each other, where each filtering screen 212a-c may be designed to trap and separate aggregates in a specific grain size range. The top filtering screen 212a may separate the large aggregates 302 from the diluted concrete slurry 223, the middle filtering screen 212b may separate the medium aggregates 304, and the lower filtering screen 212c may separate the small aggregates 306 from the diluted concrete slurry 223. Such separation may be done by designing the mesh spacings 301a-c in the filtering screens 212a-c to be smaller than the aggregate grain size to be trapped and separated, and the filtering screens 212a-c may also vibrate to allow the smaller aggregates to pass through the mesh openings. Each level of filtering screen 212a-c may have spray bars 214 (see FIG. 2) above the screen to spray water on top of the diluted concrete slurry 223 while the slurry is traveling through the vibrating filter screens 212a-c to help separate the aggregates. Each level of spray bars 214 corresponding to a level of filtering screen 212a-c may spray water above and across the filtering screen 212a-c by a flow rate ranging between 50 to 250 gallons per minute. The total water flow rate of all of the spray bars 214 of the mesh filtering system 208 may range between 150 to 500 gallons per minute.

Each mesh filtering screen 212a-c may have a length between 10 to 20 feet and a width between 10 to 20 feet and be configured to vibrate. The top mesh filtering screen 212a may have mesh openings 301a narrow enough to trap and separate large aggregates 302 in the diluted concrete slurry 223, the large aggregates 302 having grain sizes greater than or equal to 1 inch. The mesh openings 301a of the top mesh filtering screen 212a may be wide enough to allow the rest of the aggregates having smaller grain size than the large aggregates 302 to pass through to the next layers of filtering. The middle mesh filtering screen 212b may have mesh openings 301b narrow enough to trap and separate medium aggregates 304 in the diluted concrete slurry 223, the medium aggregates 304 having grain sizes greater than or equal to ⅜ inch. Since the top mesh filtering screen 212a already filtered out bigger aggregates, the middle mesh filtering screen 212b may separate aggregates having grain size in the range of greater than or equal to ⅜ inch and less than 1 inch. The mesh openings 301b of the middle mesh filtering screen 212b may be wide enough to allow the rest of the aggregates having smaller grain size than the medium aggregates 304 to pass through to the next layer of filtering. The mesh openings 301b of the middle mesh screen 212b may be narrower than the mesh opening 301a of the top mesh screen 212a but wider than the mesh opening 301c of the bottom mesh filtering screen 212c. The bottom mesh filtering screen 212c may have mesh openings 301c narrow enough to trap and separate small aggregates 306 in the diluted concrete slurry 223 having grain sizes greater than or equal to ⅛ inch. Since the above mesh filtering screen 212a-b already filtered out bigger aggregates, the bottom mesh filtering screen 212c may separate aggregates having grain size in the range of greater than or equal to ⅛ inch and less than ⅜ inch. The mesh openings 301c of the bottom mesh filtering screen 212c may be wide enough to allow the rest of the aggregates having smaller grain size than the small aggregates 306 (e.g., fine aggregates 308, extra fine aggregates 310, and ultrafine aggregates 312) to pass through to the slurry refiner 100, described elsewhere herein. The filtering by aggregate size on each mesh filtering screen 212a-c described herein is by example and not limitation. Any other combination of filtering by size may be used between the mesh filtering screens 212a-c (e.g., bottom mesh filter 212c filtering aggregates greater than or equal to ¼ inch).

The aggregates separated by size at each level of the mesh filtering system 208 may be conveyed and stored by size for recycling and remaking fluid-concrete 226. The rest of the diluted concrete slurry 223 having finer aggregates (e.g., less than ⅛ inch grain size) may flow downstream towards the slurry refiner 100. Alternatively, the mesh filtering system 208 may be configured to filter aggregates greater than or equal to ¼ inch and allow the aggregates less than ¼ inch to flow downstream to the slurry refiner 100 (e.g., bottom filtering screen 212c filtering aggregates having grain sizes greater than or equal to ¼ inch). The slurry refiner 100 may be the device that allows for a viable way to also separate and recycle the finer aggregates that are still remaining in the diluted concrete slurry 223 and could not be filtered by the mesh filtering system 208.

At the entry point of the slurry refiner 100, there may exist a turbulent discharge 224 of the diluted concrete slurry 223 to allow the remaining finer aggregates (e.g., less than ⅛ inch grain size) within the slurry to separate from the cement particles and other ultra fine aggregates. The turbulent discharge 224 may be above the slurry refiner 100 proximate to a first longitudinal end 132a of the container body 102 (see FIG. 3B). A second pipe 210b fluidly connected to the mesh filtering system 208 may create the turbulent discharge 224 of the diluted concrete slurry 223 having finer aggregates. The second pipe 210b may have a diameter of 12 to 24 inches and allow the diluted concrete slurry 223 to burst out turbulently into the slurry refiner 100 due to the pressure of the upstream water source 222 and the water from the spray bars 214. The flow rate of the turbulent discharge 224 may be the combination of the flow rate of the diluted concrete slurry 223 and the water from the spray bars 214, described elsewhere herein. The flow rate of the turbulent discharge 224 may be greater than or equal to 1,250 gallons per minute. The flow rate of the turbulent discharge 224 may be less than or equal to 3,000 gallons per minute. The flow rate of the turbulent discharge 224 may range from 1,250 to 3,000 gallons per minute, for example 2,350 gallons per minute. The bursting out at the turbulent discharge point 224 may agitate the diluted concrete slurry 223 to the point where the finer aggregates separate from unwanted particles, such as cement binders, when entering the container body 102 of the slurry refiner 100.

The container body 102 of the slurry refiner 100 receiving the turbulent discharge 224 may allow the agitated fine 308 and extra fine 310 aggregates of the diluted concrete slurry 223 to settle at the bottom (see FIG. 3B) of the container body 102. As shown in FIG. 3F, the container body 102 and its storage cavity may have a V-shaped cross-section, with the width of the container body 102 and its storage cavity narrowing when moving towards the bottom 138 to allow the fine 308 and extra fine aggregates 310 to settle down towards the one or more augers 120a-b (see FIG. 3B). The heigh boundary defining the bottom 138 of the container body 102 (see FIG. 3F) may be defined by the diameter of the auger blades 122 of the one or more augers 120a-b. Specifically, the bottom boundary 138 may be defined by the outer edges of the auger blades extending upwards in the container body 102, as shown in FIG. 3F. The cement binders and the ultra-fine aggregates 312 may float above the separated fine 308 and extra fine 310 aggregates and above the bottom boundary 138 set by the auger blades 122 within the container body 102. Some of the ultra-fine aggregates 312 may also settle at the bottom 138 of the container body 102 (see FIG. 3B). The agitated fine aggregates 308 may be in the range of less than or equal to ⅛ inch but greater than or equal to 1/32 inch grain size, and the agitated extra fine aggregates 310 may be in the range of less than 1/32 inch but greater than or equal to 1/64 inch grain size. In other examples, the agitated fine aggregates 308 entering the container body 102 of the slurry refiner 100 may be less than or equal to ¼ inches and settle at the bottom 138. The ultra-fine aggregates 312 may be in the range of less than 1/64 inch but greater than or equal to 1/128 inch grain size. It should be noted that the grain size definitions for fine, extra fine, and ultra-fine provided herein is for reference only and the grain size definitions may be categorized in other combinations of the grain size of the aggregates provided elsewhere herein.

Since the weight of the larger sized fine aggregates 308 may be greater than the smaller sized extra fine aggregates 310, 312, the heavier aggregates may settle at the bottom 138 closer to the first longitudinal end 132a of the container body 102 (see FIG. 3B) and where the turbulent discharge 224 is located, as described elsewhere herein. The smaller sized extra fine aggregates 310, 312 may settle to the bottom 138 of the container body 102 proximate to the center length of the augers 120a-b or even proximate to the second longitudinal end 132b of the container body 102. The settling of the smaller sized aggregates 310, 312 at the aforementioned location in the container body 102 may be because such smaller sized aggregates weigh less than the larger sized fine aggregates 308 and would float more in the diluted concrete slurry 223 inside the container body 102. The division of the fine aggregates 308 with the extra fine aggregates 310, and even ultra-fine aggregates 312, caused by their difference in weight may be remedied using a mixture and conveyance mechanism of the slurry refiner 100. The one or more augers 120a-b of the slurry refiner 100 may be designed to rotate and transfer the larger sized fine aggregates 308 from the first longitudinal end 132a of the container body 102 to the second longitudinal end 132b and mix the larger aggregates with the smaller fine aggregates 310, 312 at the bottom 138 of the container body 102 to create a uniform slurry mixture (see FIG. 3C) to be fed to the hydrocyclone 218 (see FIG. 2). The auger blades 122 may be spiral-shaped to allow such movement and mixture. The uniform slurry mixture may allow the hydrocyclone 218 to separate the aggregates better than if the diluted slurry mixture 223 was fed directly from the mesh filtering system 208 without using the slurry refiner 100. As shown in FIG. 2, an outlet pipe 210c may be coupled to the bottom 138 of the V-shaped container body 102 at the second longitudinal side 132b (see FIG. 3A) to transfer the uniform slurry mixture created by the slurry refiner 100 to the hydrocyclone 218 using a slurry pump 216.

Referring back to FIG. 3B-C, the structural features of the slurry refiner 100 will be described herein. The container body 102 may have a storage cavity with a length 136 greater than or equal to 10 feet. The length 136 of the storage cavity may be less than or equal to 16 feet. The length 136 of the storage cavity of the container body 102 may be in the range of 10 to 16 feet. The container body 102 may have a storage cavity with a maximum width 134 of greater than or equal to six feet. The maximum width of the storage cavity may be less than or equal to 12 feet. The maximum width 134 of the storage cavity of the container body 102 may be in the range of six to 12 feet. As described elsewhere herein, the width of the storage cavity of the container body 102 may narrow into a V-shape (see FIG. 3F) when moving deeper towards the bottom surface of the container body 102. Such V-shape may help gather the fine and extra fine aggregates that are heavier towards the one or more augers 120a-b by allowing such aggregates to slide along the V-shaped surfaces towards the augers. The storage cavity may have a minimum width at the bottom surface of the V-shape in the range of one to six feet. The container body 102 may have a storage cavity with a depth 140 (see FIG. 3E) greater than or equal to five feet. The storage cavity may have a depth 140 less than or equal to 10 feet. The depth of the storage cavity of the container body 102 may be in the range of five to 10 feet. Such large dimension of the storage cavity of the container body 102 may allow for the turbulent discharge 224 entering the slurry refiner 100 to slow down and allow the leftover finer aggregates within the diluted slurry mixture 223 to settle to the bottom 138 and bottom surface of the container body 102.

As shown in FIG. 1, the outside of the container body 102 may be supported and elevated off the ground by a plurality of supporting structures 104. Such supporting structures 104 may include vertical beams 112 connected to longitudinal beams 114 to make rectangular-shaped structures along the length of the container body 102 of the slurry refiner 100. The vertical beams 112 may elevate the container body 102 upwards from the ground. One or more diagonal beams 118 may extend in between the rectangular-shaped structures created by the vertical and longitudinal beams 112, 114 for additional support. The outside of the container body 102 may also be supported by lateral beams 116 connecting the rectangular-shaped structures formed by the beams 112, 114 on each side of the container body 102 and slurry refiner 100. The lateral beams 116 may have diagonal beams 118 therebetween as well. The outside surface of the container body 102 may have a plurality of support ribs 120 designed to add thickness to the container body 102 holding the great weight of the slurry concrete water. The container body 102 and the storage cavity therein may also have a V-shape, where the width of the container body 102 may narrow when reaching the bottom 138 of the container body 102. The V-shape and narrowing in width when extending down in the depth of the container body 102 may direct the fine, extra fine, and even some of the ultra-fine aggregates towards the one or more augers 120a-b for mixing and conveying (see FIGS. 3B-C).

As shown in FIG. 3E, the slurry refiner 100 may have an electric drive motor 106 that may be either proximate to the second longitudinal side 132b (see FIG. 3B) or the first longitudinal side 132a of the container body 102. The electric drive motor 106 may drive and rotate the one or more augers 120a-b extending inside and along the length of the container body 102. The electric drive motor 106 may be above the container body 102 and be coupled to the one or more augers 120a-b at the bottom 138 of the container body 102 using a chain and belt system that may be within an exterior belt/chain housing 108. The exterior housing 108 may be attached outside of one longitudinal end of the container body 102. The chain and belt system inside the exterior housing 108 may be rotatably coupled to the coupling ends of the one or more augers 120a-b extending out of the container body 102. The electric drive motor 106, the chain and belt system, and the external housing 108 may be removable attached to the outside of the container body 102 and the coupling ends of the augers 120a-b. The one or more augers 120a-b may each also have a second end 110 (see FIG. 1A) rotatable coupled to the other longitudinal end of the container body 102.

As shown in FIGS. 3B-C, the one or more augers 120a-b may be located at the center of the maximum width 134 of the storage cavity of the container body 102 and extend along the length 136 of the container body 102. Specifically, the one or more augers 120a-b may be located at the bottom of the V-shape of the storage cavity of the container body 102. Alternatively, the one or more augers 120a-b may be distributed symmetrically along the width 134 of the container body 102, and its storage cavity, when the storage cavity is not V-shaped but another shape (e.g., rectangular). The slurry refiner 100 may have between one to eight augers 120a-b. The one or more augers 120a-b may be placed adjacent side-by-side to each other. Alternatively, the one or more augers 120a-b may be placed above each other. The one or more augers 120a-b may rotate either clockwise or counterclockwise depending on how the auger blades 122 are shaped to transfer and mix a uniform slurry mixture from one longitudinal end 132a to the other longitudinal end 132b of the container body 102. The plurality of augers 120a-b may all rotate in the same direction (e.g., clockwise or counterclockwise). The plurality of augers 120a-b may be paired up together and each auger 120a-b in the pair may rotate in the opposite direction of the other pair, depending on how the auger blades 122 of each auger 120a-b in the pair are shaped to transfer and mix the uniform slurry mixture. The one or more augers 120a-b may each rotate at a rate greater than or equal to 10 RPM. The one or more augers 120a-b may each rotate at a rate less than or equal to 80 RPM. The one or more augers 120a-b may each rotate in the range of 10 to 80 RPM. The calibration of the revolutions per minute of the one or mor augers 120a-b may depend on the size of the slurry refiner 100 and the content and composition of the diluted concrete slurry 223 fed to the device at the turbulent discharge 224. For example, having a greater amount of aggregate in the slurry mixture, which such aggregates were not filtered by the mesh filtering system 208, may require the augers 120a-b to rotate at a slower RPM to create a more uniform slurry mixture.

As shown in FIG. 3C, the one or more augers 120a-b may be the structures that rotate to transfer and mix a uniform slurry mixture from one longitudinal end 132a to the other longitudinal end 132b of the storage cavity of the container body 102, described elsewhere herein. The container body 102 of the slurry refiner 100 and its storage cavity may have a V-shaped cross-section (see FIG. 3F) and have a width that narrows when reaching the bottom of the container and the one or more augers 120a-b. This may allow the fine 308 and extra fine 310 aggregates that are heavier to slide and settle towards the augers 120a-b for mixing and transferring. As shown in FIG. 3C, the auger blades 122 may create a flow 128 within the container body 102 that draws the diluted concrete slurry 223 to be mixed inwards towards the one or more augers 120a-b (i.e., away from the longitudinal sides 130a-b of the container body 102) and forward from a first end 126a of the augers 120a-b to the second end 126b of the augers 120a-b inside the container body 102, as described elsewhere herein. The auger blades 122 may have a blade diameter that is large enough to mix and transfer the aggregates, described elsewhere herein, that settle at the bottom 138 of the container body 102. The auger blades 122 may be concave spiral fin-shaped to scoop and draw the slurry mixture inwards towards the augers 120a-b and forward towards the second longitudinal end 132b of the container body 102. The first end 126a of the one or more augers 120a-b may be located on the same side as the first longitudinal end 132a of the storage cavity of the container body 102 (see FIG. 3B), and where the second pipe 210b (see FIG. 2) creating the turbulent discharge 224 is located. The second end 126b of the one or more augers 120a-b may be located on the same side as the second longitudinal end 132b of the storage cavity of the container body (see FIG. 3B), and where a slurry refiner outlet pipe 210c (see FIG. 2) transferring the uniformly mixed slurry to a slurry pump 216 is located.

As shown in FIG. 3C, the one or more augers 120a-b may be designed to transfer the larger sized fine aggregates 308 from the first longitudinal end 132a of the container body 102 to the second longitudinal end 132b and mix the larger aggregates with the smaller aggregates 310, 312 at the bottom 138 of the container body 102 to create a uniform slurry mixture to be fed to the hydrocyclone 218 (see FIG. 2). As described elsewhere herein, the larger sized fine aggregates 308 (e.g., less than or equal to ⅛ inch but greater than or equal to 1/32 inch grain size) may settle at the bottom 138 proximate to the first longitudinal end 132a of the container body 102. As described elsewhere herein, the extra fine aggregates 310 (e.g., less than 1/32 inch but greater than or equal to 1/64 inch grain size) may settle at the bottom 138 proximate to the middle of the container body 102, and even some of the ultra-fine aggregates 312 (e.g., less than 1/64 inch but greater than or equal to 1/128 inch grain size) may settle at the bottom 138 proximate the center and the second longitudinal end 132b of the storage cavity of the container body 102. As the augers 120a-b rotate, and as shown in FIG. 3C, the auger blades 122 transfer the fine aggregates 308 from the first end 126a of the augers 120a-b to the second end 126b of the augers 120a-b while mixing the fine aggregates 308 with the extra fine aggregates 310 and some of the ultra-fine aggregates 312 to create a uniform mixture. The uniform mixture is then supplied to a hydrocyclone 218 via a slurry pump 216, as described elsewhere herein.

The outlet pipe 210c connected to the bottom 138 of the second longitudinal end 132b of the container body 102 may be fluidly connected to a slurry pump 216 that pumps the uniform mixture formed by the slurry refiner 100 to the hydrocyclone 218. The pump flow rate of the slurry pump 216, from the slurry refiner 100 to the hydrocyclone 218, may be less than the turbulent discharge 224 flow rate entering the slurry refiner 100. Alternatively, the pump flow rate of the slurry pump 216 may equal the turbulent discharge 224 flow rate. The pump flow rate of the slurry pump 216 may be greater than or equal to 1,000 gallons per minute. The pump flow rate of the slurry pump 216 may be less than or equal to 2,750 gallons per minute. The pump flow rate of the slurry pump 216 may be in the range of 1,000 to 2,750 gallons per minute. As a result, some of the turbulent discharge 224, particularly the portion of the slurry having the ultra-fine aggregates and cement particles, may overflow out of the top of the slurry refiner 100 and into a sump structure 118 around the slurry refiner 100. For example, if the turbulent discharge 224 flow rate is 2,350 gallons per minute and the pumping flow rate out of the slurry refiner 100 (e.g., via the outlet pipe 210c) is 2,000 gallons per minute, then 350 gallons per minute may overflow from the top of the slurry refiner 100 and into the sump structure 118 around the slurry refiner 100. The sump 118 may have walls surrounding the slurry refiner 100 and collect the overflow having the ultra-fine aggregates and cement particles. The sump 118 may have a drain to allow the overflow to be transferred out of the sump 118 and to be press-fitted to further recycle the ultra-fine aggregates and the water forming the slurry. The water from the sump 118 that is press-fitted may be recycled, transferred, and used as the recycled water 222 in the beginning of the concrete reclaimer system 200.

As described elsewhere herein, the slurry pump 216 may pump the uniform mixture of the diluted concrete slurry 223 out of the bottom of the slurry refiner 100 via an outlet pipe 210c connected to an inlet of the slurry pump 216. The outlet of the slurry pump 216 may have a third pipe 210d fluidly connected to an inlet of the hydrocyclone 218 where the pump 216 feeds the uniform slurry mixture to the inlet of the hydrocyclone 218. As described elsewhere herein, the pump rate of the slurry pump 216 may be less than or equal to the turbulent discharge 224 rate entering the slurry refiner 100.

The hydrocyclone 218 may better perform in separating fine and extra fine aggregate from the rest of what is left in the the concrete slurry 223 when such device is fed the uniform mixture created by the slurry refiner 100. The hydrocyclone 218 may even separate some of the ultra-fine aggregates remaining in the uniform mixture. As shown in FIG. 3D, the hydrocyclone 218 may be a high-throughput gravity separation device that uses centrifugal force and gravity to separate the aforementioned aggregates from water, cement binders, and other unwanted particles. The fine 308 and extra fine 310 aggregates (e.g., the grain sizes described elsewhere herein) may be separated from the rest of the uniform mixture and drop in the underflow 218b of the hydrocyclone 218. The ultra-fine aggregates 312 may separate and exit from the overflow 218a. In some examples, even some ultra-fine aggregates 312 may be separated from the uniform mixture and fall in the underflow 218b of the hydrocyclone 218. The separated aggregate from the uniform mixture may then be transferred, stored, and reused to make another batch of fluid-concrete. Water, cement binders, and other unwanted particles (e.g., ultra-fine aggregates 312) may flow upward out of the overflow 218a of the hydrocyclone 218 via an upward vortices spiral. The water separated by the hydrocyclone 218 may be recycled, transferred, and be used as the recycled water 222, described elsewhere herein, in the beginning of the concrete reclaimer system 200.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of recycling differently sized aggregates from fluid-concrete, comprising:
discharging the fluid-concrete in a receiving hopper at a first volumetric flow rate;
diluting the fluid concrete with water having a second volumetric flow rate flowing inside the receiving hopper to create a diluted concrete slurry, the second volumetric flowrate being larger than the first volumetric flow rate;
filtering larger aggregates from the diluted concrete slurry using a mesh filtering system;
flowing the diluted concrete slurry in a pipe having a turbulent discharge that opens up to a slurry refiner, the turbulent discharge separating remaining smaller aggregates from cement binders in the diluted concrete slurry;
mixing the remaining smaller aggregates in the diluted concrete slurry using one or more rotating augers of the slurry refiner; and
pumping the diluted concrete slurry from the slurry refiner to a hydrocyclone for separating the remaining smaller aggregates from water and cement binders in the diluted concrete slurry.

2. The method of claim 1, wherein the second volumetric flow rate is between 5 to 100 times greater than the first volumetric flow rate.

3. The method of claim 1, wherein the remaining smaller aggregates in the diluted concrete slurry each have a grain size less than or equal to ⅛ inches.

4. The method of claim 3, further comprising moving the remaining smaller aggregates that are being mixed from a first end to a second end of the slurry refiner using the one or more rotating augers.

5. The method of claim 1, wherein the remaining smaller aggregates in the diluted concrete slurry each have a grain size less than or equal to ¼ inches.

6. The method of claim 1, wherein the mesh filtering system comprises a plurality of vibrating mesh screens and a plurality of water spray bars.

7. The method of claim 1, further comprising collecting an overflow of the diluted concrete slurry flowing from a top of the slurry refiner using a sump.

8. The method of claim 1, wherein water separated by the hydrocyclone is recycled and flown into the receiving hopper for diluting additional batches of fluid concrete.

9. A method of using a slurry refiner to create a uniform mixture of diluted concrete slurry to be fed to a filtering device, comprising:
turbulently discharging the diluted concrete slurry inside the slurry refiner, the turbulent discharge separating fine aggregates and extra fine aggregates of the diluted concrete slurry from cement binders;
settling the fine aggregates and extra fine aggregates near a bottom surface of the slurry refiner;
mixing the fine aggregates and extra fine aggregates near the bottom surface of the slurry refiner by rotating one or more augers extending along a length of a storage cavity of the slurry refiner;
transferring the fine aggregates and extra fine aggregates being mixed along the length of the storage cavity to an outlet having a slurry pump coupled therewith, the transferring happening by rotating the one or more augers having auger blades that create translational fluid motion when the auger blades are rotated; and
pumping the mixed fine aggregates and extra fine aggregates to the filtering device for separation.

10. The method of claim 9, wherein the diluted concrete slurry goes through a mesh filtering system that is upstream from the turbulent discharge of the diluted concrete slurry inside the slurry refiner.

11. The method of claim 10, wherein the mesh filtering system filters large, medium, and small aggregates from the diluted concrete slurry.

12. The method of claim 11, wherein the diluted concrete slurry is created by mixing a first volume of fluid-concrete with a second volume of water, the second volume being at least five time greater than the first volume.

13. The method of claim 11, wherein the fine aggregates each have a grain size less than or equal to ¼ inches.

14. The method of claim 13, wherein the fine aggregates each have a grain size less than or equal to ⅛ inches.

15. The method of claim 14, wherein the extra fine aggregates each have a grain size less than or equal to 1/32 inches.

16. The method of claim 9, wherein the length of the storage cavity of the slurry refiner is at least 10 feet, and the storage cavity has a depth that is at least 5 feet and a maximum width that is at least 7 feet.

17. A slurry refiner used for recycling fine and extra fine aggregates of fluid-concrete, comprising:
a container structure having a storage cavity with an open top and a bottom surface, the storage cavity having a length, a depth, and a narrowing width creating a V-shape from the open top to the bottom surface;
a support structure attached and surrounding the container structure;
one or more augers extending along the length of the storage cavity and rotatably coupled near the bottom surface and in a middle of the V-shape of the storage cavity of the container structure;
an electric drive motor attached to the container structure for rotating and driving the one or more augers; and
a belt system rotatably coupling the electric drive motor to the one or more augers.

18. The slurry refiner of claim 17, wherein the one or more augers comprise at least two augers.

19. The slurry refiner of claim 18, wherein the at least two augers are configured to rotate in opposite directions relative to each other.

20. The slurry refiner of claim 17, wherein the length of the container structure is at least 10 feet and the depth of the container structure is at least 5 feet.
